(19) United States
(12) Patent Application Publication
(10) Pub. No.: US 2024/0256610 A1
(43) Pub. Date: Aug. 1, 2024

(54) Device and Method for Generating Cardinality Prediction Model for Approximate Substring Query

(71) Applicants: SEOUL NATIONAL UNIVERSITY R&DB FOUNDATION, Seoul (KR); INDUSTRY-UNIVERSITY COOPERATION FOUNDATION HANYANG UNIVERSITY ERICA CAMPUS, Gyeonggi-do (KR)

(72) Inventors: Suyong Kwon, Seoul (KR); Kyuseok Shim, Seoul (KR); Woohwan Jung, Gyeonggi-do (KR)

(21) Appl. No.: 18/424,486

(22) Filed: Jan. 26, 2024

(30) Foreign Application Priority Data
Jan. 27, 2023 (KR) 10-2023-0011058

(51) Int. Cl. G06F 16/9032; G06N 3/042

(52) U.S. Cl. CPC G06F 16/90324; G06N 3/042

(57) ABSTRACT

The present disclosure relates to a deep learning model for cardinality prediction and, more specifically, to a method for generating and training a model for predicting a cardinality for a similarity query in consideration of a substring condition based on an edit distance.

### CROSS-REFERENCE TO RELATED APPLICATION(S)

This application is based on and claims priority under 35 U.S.C. 119 to Korean Patent Application No. 10-2023-0011058, filed on Jan. 27, 2023, in the Korean Intellectual Property Office, the disclosure of which is herein incorporated by reference in its entirety.

### BACKGROUND OF THE INVENTION

### 1. Field of the Invention

The present disclosure relates to a deep learning model for cardinality prediction and, more specifically, to a method for generating and training a model for predicting a cardinality for a similarity query in consideration of a substring condition based on an edit distance.

### 2. Description of the Prior Art

In order to perform string query optimization in commercial database system software, such as Oracle, SQL Server (MS), or DB2 (IBM), a size (cardinality) for a result of a string similarity query is required.

Prior research involves creating summary information based on substrings included in data strings and a frequency with which each substring appears in the entire data string, and then predicting, using the frequency, a size (cardinality) for a query result for a substring similarity query using an edit distance.

Recently, there has been prior research on cardinality prediction techniques using deep learning for a string similarity query, but there has been no research on predicting a cardinality by applying deep learning to a substring similarity query using an edit distance.

Cardinality refers to a total number of rows processed at each level in the next query or query execution scheme.

Conventionally, a cardinality has been predicted based on some stored information mainly via a statistical assumption. When such an assumption is not correct, there is a problem that a cardinality prediction result is inaccurate.

### SUMMARY OF THE INVENTION

Therefore, an aspect of the present disclosure is providing an algorithm for predicting a cardinality for a substring similarity query by using a deep learning model, and efficiently and quickly generating training data for the same.

The present disclosure is not limited to the description above, and other aspects that are not mentioned may be clearly understood by those skilled in the art to which the present disclosure belongs, from descriptions below.

A method for generating a cardinality prediction model for an approximate substring query according to an embodiment of the present disclosure as described above may include: receiving a query string set for a data string set stored in a database; configuring a maximum distance threshold for a substring edit distance defined as the closest distance among edit distances between a query string and all possible substrings of a data string; generating training data including a pair of a query, which satisfies a condition that a substring edit distance needs to be smaller than the maximum distance threshold, and a cardinality for the query; and training, using the training data, a deep learning model to predict a cardinality for an approximate substring query.

A device for generating a cardinality prediction model for an approximate substring query according to another embodiment of the present disclosure may include a processor, and a memory connected to the processor and configured to store at least one code executed by the processor, wherein the processor is configured to perform: receiving a query string set for a data string set stored in a database; configuring a maximum distance threshold for a substring edit distance defined as the closest distance among edit distances between a query string and all possible substrings of a data string; generating training data including a pair of a query, which satisfies a condition that a substring edit distance needs to be smaller than the maximum distance threshold, and a cardinality for the query; and training, using the training data, a deep learning model to predict a cardinality for an approximate substring query.

A method for training a deep learning model for cardinality prediction according to an embodiment of the present disclosure can be applied to a system, which predicts a cardinality for a given substring similarity query in a database system, to increase the accuracy of cardinality prediction, and can generate a better query execution scheme for quick query execution to speed up a query execution time, thereby improving the performance of the database system.

The effects of the present disclosure are not limited to the description above, and other effects that are not mentioned may be clearly understood by those skilled in the art to which the present disclosure belongs, from descriptions below.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a block diagram of a cardinality prediction model generation device according to an embodiment of the present disclosure;

FIG. 2 is a flowchart schematically illustrating a method for generating a cardinality prediction model according to an embodiment of the present disclosure;

FIG. 3 illustrates table D for calculation of a substring edit distance according to an embodiment of the present disclosure;

FIG. 4 illustrates an example of a trie structure;

FIG. 5 illustrates an arrangement table D;

FIG. 6 illustrates an example of a query ordering scheme including a sorting-based training data generation algorithm (SODDY) and a trie-based training data generation algorithm (TEDDY) with respect to string data of“joseph biden” and three query strings of“jo”, “joe”, and “john”;

FIG. 7 shows pseudo-codes for the sorting-based training data generation algorithm (SODDY);

FIG. 8 shows pseudo-codes for the trie-based training data generation algorithm (TEDDY);

FIG. 9 is a structural diagram illustrating a structure of a cardinality prediction deep learning model according to an embodiment of the present disclosure;

FIG. 10 illustrates an example of a data string set and a query string set;

FIG. 11 illustrates an example for query string set S_{Q} and string set S_{D};

FIG. 12 illustrates an example of prefix-augmented training data;

FIG. 13 shows a flowchart illustrating a procedure of generating training data by using the sorting-based training data generation algorithm (SODDY);

FIG. 14 shows a flowchart illustrating a procedure of generating training data by using the trie-based training data generation algorithm (TEDDY); and

FIG. 15 shows a flowchart for illustrating a cardinality prediction model generation procedure according to an embodiment of the present disclosure.

### DETAILED DESCRIPTION OF THE EXEMPLARY EMBODIMENTS

The objectives and effects of the present disclosure and technical configurations for achieving the same will be apparent by making reference to embodiments described in detail below along with the accompanying drawings. In description of the present disclosure, a detailed description of a related known function or configuration will be omitted if it is deemed to make the gist of the present disclosure unnecessarily vague. Furthermore, terms to be described hereinafter are terms defined in consideration of structures, roles, and functions in the present disclosure, and may vary depending on intention, usage, or the like of users or operators.

However, the present disclosure is not limited to the embodiments disclosed below and may be implemented in various different forms. The embodiments are merely provided to complete the disclosure of the present disclosure and to fully inform those skilled in the art, to which the present disclosure belongs, of the scope of the present disclosure, and the present disclosure is defined solely by the scope of claims stated in the claims. Therefore, the definitions should be made based on content throughout the specification.

Throughout the specification, when apart is said to “include” an element, this indicates that the part may further include other elements rather than excluding other elements, unless specifically stated to the contrary.

Hereinafter, with reference to the accompanying drawings, preferred embodiments of the present disclosure will be described in more detail.

The present disclosure proposes an algorithm for predicting a cardinality for a substring similarity query by using a deep learning model, and efficiently and quickly generating training data for the same.

Training data is a set including a pair of a query and a cardinality therefor.

In order to generate training data, substring edit distances between a data string and all query strings existing in the training data need to be calculated, wherein, for efficiently generating the training data, if there is a common intermediate computation result when calculating the substring edit distances between the data string and multiple query strings, the calculation may be performed only once, and for query strings that are not similar to the data string, when the dissimilarity is identified using a lower bound of the substring edit distances according to an embodiment of the present disclosure, distance calculation may be skipped to enable the training data to be generated quickly.

In addition, for a deep learning model proposed in the present disclosure, query strings appear as a series of characters, and therefore a sequential model is used.

In the present disclosure, a deep learning model is trained to predict not only a cardinality for a given query, but also cardinalities for all queries made with a prefix of a query string, so as to improve prediction accuracy for a cardinality of a substring similarity query of the model.

In this case, for faster training, a packed learning method is proposed. Accordingly, this technique has greatly improved accuracy compared to a model generation time obtainable from an existing state of the art.

Broadly speaking, the present disclosure provides a procedure of generating training data from given data, and a procedure of training a deep learning model for cardinality prediction via training data.

When a set of query strings and a data string are given based on a database, training data needs to be generated by calculating a cardinality for each of the query strings.

When training data is generated via algorithms proposed in the present disclosure, the training data is generated much faster compared to a method of calculating a cardinality one by one for each query.

Training a deep learning model to predict not only a cardinality for a given query, but also cardinalities for all queries made with a prefix of a query string improves prediction accuracy for a cardinality of a substring similarity query of the model.

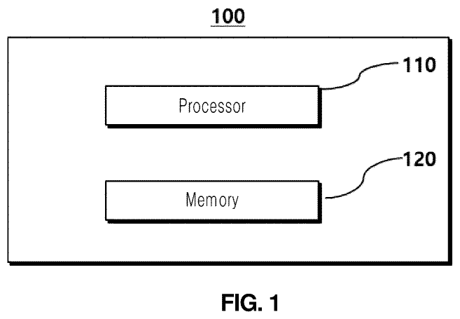

FIG. 1 is a block diagram of a cardinality prediction model generation device according to an embodiment of the present disclosure.

A cardinality prediction model generation device 100 according to an embodiment of the present disclosure includes a processor 110 and a memory 120.

The processor 110 is a type of a central processing unit and may execute a function optimization method according to an embodiment by executing one or more instructions stored in the memory 120. The processor 110 may include any type of device capable of processing data.

The processor 110 may refer to, for example, a data processing device embedded in hardware, the device having a physically structured circuit to perform a function expressed as a code or a command included in a program. As an example, the data processing device embedded in hardware may encompass, but may not be limited to, processing devices, such as a microprocessor, a central processing unit (CPU), a processor core, a multiprocessor, an application-specific integrated circuit (ASIC), a field programmable gate array (FPGA), and a graphics processing unit (GPU). The processor 110 may include one or more processors. The processor 110 may include at least one core.

The memory 120 may store instructions, etc. for the cardinality prediction model generation device 100 according to an embodiment to generate a cardinality prediction model. The memory 120 may store an executable program that generates and executes one or more commands implementing a cardinality prediction model according to an embodiment.

The processor 110 may execute a memory management method according to an embodiment, based on programs and instructions stored in the memory 120.

The memory 120 may include an internal memory and/or an external memory, and may include a volatile memory, such as a DRAM, an SRAM, or an SDRAM, a non-volatile memory, such as a one-time programmable ROM (OTPROM), a PROM, an EPROM, an EEPROM, a mask ROM, a flash ROM, a NAND flash memory, or a NOR flash memory, a flash drive, such as an SSD, a compact flash (CF) card, an SD card, a Micro-SD card, a Mini-SD card, an XD card, or a memory stick, or a storage device such as an HDD. The memory 120 may include a magnetic storage medium or a flash storage medium, but is not limited thereto.

The processor 110 may first receive a query string set for a data string set stored in a database.

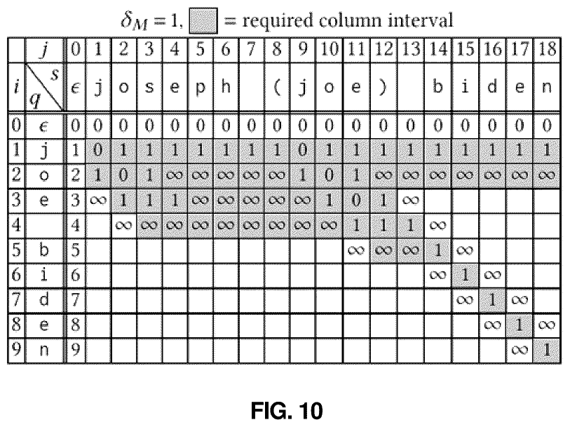

FIG. 10 illustrates an example of a data string set and a query string set.

Next, the processor 110 may configure a maximum distance threshold for a substring edit distance defined as the closest distance among edit distances between a query string and all possible substrings of a data string.

Here, for an edit distance, when two strings s₁,s₂ are given, edit distance d(s₁,s₂) for s₁,s₂ refers to a minimum number of operations required to make s₁ into s₂ by using three operations (insertion, deletion, and substitution).

A substring from position i to position j of string s may be defined to be s[i,j].

An edit distance for two strings s₁,s₂ may be efficiently calculated using dynamic programming.

D∈R^{(|s}^{₁}^{|+1)(|s}^{₂}^{|+1)} is a two-dimensional array, and D[i,j] indicates an edit distance of s₁[1,i] and s₂ [1,j]. In this case, D[i,j] may be obtained via the following recursive equation.

$$D [ i , j ] = \{ \begin{matrix}0 & if i = 0 or j = 0 \\ D [ i - 1 , j - 1 ] & if {s}_{1} [ i ] = {s}_{2} [ j ] \\ min ( D [ i - 1 , j ] , D [ i , j - 1 ] , D [ i - 1 , j - 1 ] ) + 1 & if {s}_{1} [ i ] \neq {s}_{2} [ j ]\end{matrix}$$

$$d ( {s}_{1} , {s}_{2} ) = D [ \vert {s}_{1} \vert , \vert {s}_{2} \vert ]$$

Edit distance d (s₁,s₂) for s₁,s₂ is equal to D[|s₁|,|s₂|].

In addition, a substring edit distance is as follows.

When query string q and data string s are given, a substring edit distance for q and s is defined to be the closest distance among all edit distances between query string q and all possible substrings of s.

$${d}_{sub} ( q , s ) = {min}_{1 \leq i \leq j \leq \vert s \vert} d ( q , s [ i , j ] )$$

For example, with respect to q=“joe” and s=“joseph biden”, “jose” among all substrings of s has the closest edit distance to q, and the distance is 1, so that d_{sub}(q,s)=1.

The substring edit distance for query string q and data string s may be efficiently calculated using dynamic programming. D∈R^{(|q|+1)-(|s|+1)} is a two-dimensional array, and D[i,j] indicates a minimum value among edit distances between q[1,i] and substrings of s, which end at position j (i.e., D[i,j]=min_{1≤k≤}d (q[1,i], s[k,j])). D[i,j] may be efficiently calculated via the following recursive equation.

$$D [ i , j ] = \{ \begin{matrix}0 & if i = 0 \\ i & if j = 0 \\ D [ i - 1 , j - 1 ] & if q [ i ] = s [ j ] \\ min ( D [ i - 1 , j ] , D [ i , j - 1 ] , D [ i - 1 , j - 1 ] ) + 1 & if q [ i ] \neq s [ j ]\end{matrix}$$

$${d}_{sub} ( q , s ) = {min}_{1 \leq j \leq \vert s \vert} D ( \vert q \vert , j )$$

Substring edit distance d_{sub}(q,s) for query string q and data string s is equal to min_{1≤j≤≤|s|}D[|q|,j].

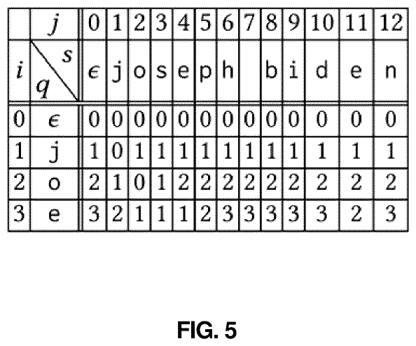

FIG. 5 shows a result of table D calculation to calculate a substring edit distance for the query string joe“and the data string joseph biden”.

The substring edit distance for the query string joe“and the data string joseph biden” is 1 which is a minimum value of row i=3 in table D.

A substring similarity query includes query string q and distance threshold δ. When the query is performed, strings, in which a substring edit distance to query string q is within δ, in string data S_{D} are returned. A cardinality of a query refers to the number of performing results of the query. Therefore, cardinality c(q,δ) of substring similarity query (q,δ) is the number of data, in which a substring edit distance to query string q is δ, in string data, and is expressed in the form of an equation as follows.

$$c ( q , δ ) = \vert \{ s \vert {d}_{sub} ( q , s ) \leq δ , s ∈ {S}_{D} \} \vert$$

It may be assumed that the string data is given as “jill biden”, “joseph biden” and “bill gates”. When calculating substring edit distances between query string q=joe and three data strings, the calculated values are 2, 1, and 2 in order. A cardinality of substring similarity query (joe, 0) is 0, and a cardinality of substring similarity query (joe, 1) is 1.

Next, the processor 110 may generate training data including a pair of a query that satisfies a condition that a substring edit distance needs to be smaller than the maximum distance threshold and the cardinality for the query.

To this end, the processor 110 may calculate a substring edit distance for a query string and a data string.

Specifically, the processor 110 may search for a common prefix of two different query strings in the query string set.

In addition, when calculating substring edit distances for the data string and query strings, substring edit distance calculation for the common prefix may be shared without repetition.

Array D used in dynamic programming for substring calculation for query string q and data string s may be referred to as D_{q,s}. When data string s is given, the following equation is satisfied for query string q and prefix p of q.

$${D}_{q , s} [ i , j ] = {D}_{p , s} [ i , j ] for 1 \leq i \leq \vert p \vert and 1 \leq j \leq \vert s \vert$$

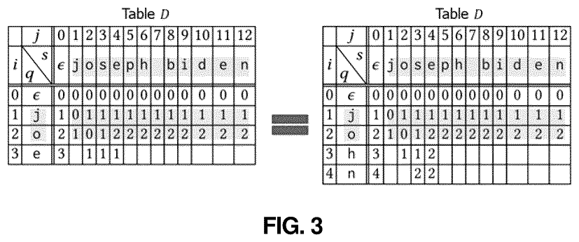

Table D calculated to obtain the substring edit distances for data string “joseph biden” and query strings “joe” and “john” is as illustrated in FIG. 3. Query strings “joe” and “john” have a common prefix of“jo”, in which case, results calculated on the table are the same.

Therefore, if table D has been calculated for query string joe“and data string joseph biden”, only row i=3 or i=4 needs to be calculated for table D calculation for query string “john” and data string “joseph biden”.

In addition, the processor 110 may exclude cardinality calculation for a data string corresponding to a case where a substring edit distance is greater than the maximum distance threshold.

Specifically, when a maximum distance threshold which may be given as an input of a substring query based on an edit distance in a database is δ_{M}, if a distance between a query string and a data string is greater than δ_{M}, the data string is not included in a query result, and may be thus ignored (pruning) when calculating a cardinality. In this case, an exact distance needs to be calculated.

Therefore, when calculating a substring edit distance to calculate a cardinality of a query, a case in which the distance is greater than maximum distance threshold δ_{M} may be identified in advance to stop the calculation in the middle, thereby reducing the amount of calculation.

In addition, the amount of calculation may be further reduced by calculating only a minimum interval required for distance calculation for a case in which a substring edit distance is smaller than maximum distance threshold δ_{M}. When calculating a substring edit distance via dynamic programming, column interval [Jₛ(i),Jₑ(i)] required for calculation in an i-th row is defined as in the following equation.

$$[ {J}_{s} ( i ) , {J}_{e} ( i ) ] = \{ \begin{matrix}[ 1 , \vert s \vert ] & if i \leq {δ}_{M} + 1 \\ [ min ( S ( i ) ⋃ \{ ∞ \} ) , max ( S ( i ) ⋃ \{ - ∞ \} ) ] & if i > {δ}_{M} + 1\end{matrix}$$

$$S ( i ) = \{ j \vert D [ i - 1 , j - 1 ] \leq {δ}_{M} , j - 1 ∈ [ {J}_{s} ( i - 1 ) , {J}_{e} ( i - 1 ) ] \}$$

A reason that only the interval above needs to be calculated is because substring edit distance calculation using dynamic programming satisfies the following equation.

$$D [ i , j ] \geq D [ i - 1 , j - 1 ]$$

On the other hand, a data string corresponding to a case in which a substring edit distance is smaller than the maximum distance threshold may be applied for the cardinality calculation.

In an embodiment, in order to generate training data, the processor 110 may use the sorting-based training data generation algorithm (SODDY) or the trie-based training data generation algorithm (TEDDY).

When the sorting-based training data generation algorithm (SODDY) is used, the processor 110 may alphabetically sort query strings in the query string set, and calculate and store a longest common prefix length for two different adjacent query strings. Accordingly, substring edit distances may be calculated while searching the query strings in a sorted order, wherein substring edit distance calculation for a common prefix may be shared without repetition.

Alternatively, when the trie-based training data generation algorithm (TEDDY) is used, the processor 110 may generate a trie based on query strings, perform a depth-first search starting from a root node of the trie, and calculate a substring edit distance for the data string starting from a longest common prefix of the query strings.

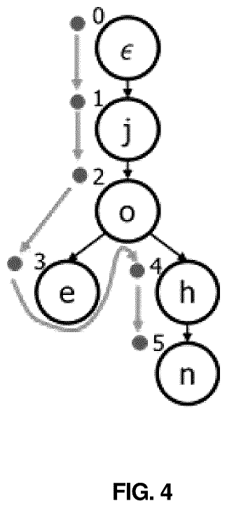

FIG. 4 illustrates an example of a trie structure.

Trie, also called prefix tree, is a tree structure for a string search. A root node refers to an empty string (empty character), and each child node is connected with a character to represent a corresponding node. When a trie is generated by receiving given strings as inputs, respective nodes indicate prefixes appearing in the strings. The prefixes indicated by respective nodes do not overlap, and indicate all prefixes existing in the strings. Starting from a root node, all prefixes appearing in data may be searched once without exception via a depth-first search. A trie structure generated when strings are given as “jo”, “joe”, and “john” is as illustrated in FIG. 4.

Node 2 in FIG. 4 indicates “jo” and indicates a prefix appearing in the strings. Arrows indicate that a depth-first search is performed from a root node and all prefixes appearing in the strings are searched once.

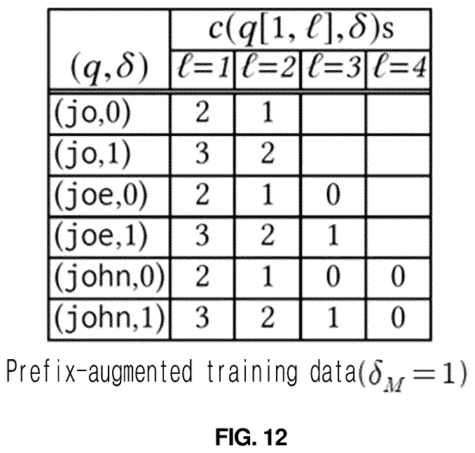

In particular, in an embodiment, the processor 110 may generate multiple prefix queries by classifying prefixes for a query, calculate cardinalities for the respective multiple prefix queries, and generate prefix-augmented training data as in the example illustrated in FIG. 12.

Accordingly, the processor 110 may receive training data including the prefix-augmented training data, and generate index set I by selecting b random indexes among indexes assigned to the training data. Subsequently, the processor 110 may configure a batch based on a unit via which training data corresponding to index set I enables training of a parameter of the deep learning model, and may update the parameter of the deep learning model, based on a loss function for cardinalities corresponding to the multiple prefix queries and the query within the batch.

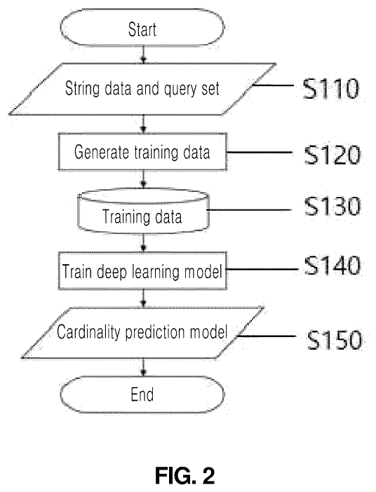

FIG. 2 is a flowchart schematically illustrating a method for generating a cardinality prediction model according to an embodiment of the present disclosure.

Referring to FIG. 2, when string data and a query set are given in a database in operation S110, the processor 110 generates, in operation S120, training data by using a pruning method and sharing common computation.

Subsequently, the processor 110 stores the training data in the memory in operation S130, and trains a deep learning model by using the training data so as to generate a cardinality prediction model, in operation S140.

Hereinafter, the sharing common computation and the pruning method for training data generation of operation S120 will be described in detail.

### <Pruning Method>

When a maximum distance that may be given as an input of a substring query based on an edit distance in a database is δ_{M} (threshold), if a distance between a query string and a data string is greater than δ_{M} (threshold), the data string is not included in a query result so as to be ignored when calculating a cardinality.

Therefore, when calculating a substring edit distance to calculate a cardinality of a query, a case in which the distance is greater than a threshold (δ_{M}) may be identified in advance, and calculation is stopped in the middle, thereby reducing the amount of calculation.

In addition, the amount of calculation may be further reduced by calculating only a minimum interval required for distance calculation for a case in which a substring edit distance is smaller than a maximum threshold (δ_{M}).

When calculating a substring edit distance via dynamic programming, column interval [Jₛ(i),Jₑ(i)] required for calculation in an i-th row is defined as in equation 1 below.

$$[ Equation 1 ]$$

$$[ {J}_{s} ( i ) , {J}_{e} ( i ) ] = \{ \begin{matrix}[ 1 , \vert s \vert ] & if i \leq {δ}_{M} + 1 \\ [ min ( S ( i ) ⋃ \{ ∞ \} ) , max ( S ( i ) ⋃ \{ - ∞ \} ) ] & if i > {δ}_{M} + 1\end{matrix}$$

$$S ( i ) = \{ j \vert D [ i - 1 , j - 1 ] \leq {δ}_{M} , j - 1 ∈ [ {J}_{s} ( i - 1 ) , {J}_{e} ( i - 1 ) ] \}$$

A reason that only the interval above needs to be calculated is because substring edit distance calculation using dynamic programming satisfies the following equation.

$$D [ i , j ] \geq D [ i - 1 , j - 1 ]$$

### <Sharing Common Computation Method>

Array D used in dynamic programming for substring calculation for query string q and data string s may be referred to as D_{q,s}. Array table D is illustrated in FIG. 5.

When data string s is given, equation 2 below is satisfied for query string q and prefix p of q.

$${D}_{q , s} [ i , j ] = {D}_{p , s} [ i , j ] for 1 \leq i \leq \vert p \vert and 1 \leq j \leq \vert s \vert \qquad [ Equation 2 ]$$

Table D calculated to obtain the substring edit distances for data string “joseph biden” and query strings “joe” and “john” is as follows.

Query strings “joe” and “john” have a common prefix of“jo”, in which case, results calculated on the table are the same.

Therefore, if table D has been calculated for query string joe“and data string joseph biden”, only row i=3 or i=4 needs to be calculated for table D calculation for query string “john” and data string “joseph biden”.

In summary, the processor 110 generates a first table and a second table, which have an array of rows and columns, to obtain a substring edit distance for the data string and each of a first query string and a second query string.

In addition, when the first query string and the second query string have a common prefix, the processor 110 may share, with the second table, a calculation result corresponding to the common prefix (row corresponding to the common prefix) in the first table.

### <Query Ordering Scheme>

Since sharing common computation may be performed for a common prefix of two different query strings, an order of searching query strings is adjusted so that sharing common computation is performed as much as possible.

The present disclosure proposes a method of searching consecutive query strings by alphabetically sorting the same and a method of searching a trie structure generated using query strings.

The generated trie structure allows prefixes appearing in the query strings to be searched without repetition.

Via the sorting-based training data generation algorithm (SODDY), the query strings are sorted alphabetically, and then a longest common prefix length for two different adjacent query strings is calculated and stored.

For each data string s, table D is calculated while searching the query strings in the sorted order.

For every query string, a row corresponding to the longest common prefix length in table D has already been calculated. Therefore, table D calculation continues from a subsequent row of a calculated part.

Via the trie-based training data generation algorithm (TEDDY), a trie is first generated from the query strings. Starting from a root node of this trie, a depth-first search is performed to first calculate table D for the longest common prefix of the query strings, and then table D for each query string is calculated.

Calculation for D_{p,s}[|p|−1,j] for 1≤j≤|s| has already been performed to calculate D_{p,s} for prefix p indicated by a node visited during the depth-first search, and thus calculation is performed only for D_{p,s}[|p|,j] for 1≤j≤|s|.

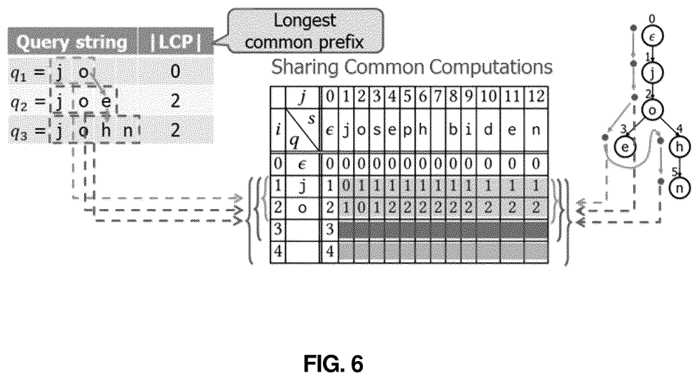

FIG. 6 illustrates an example of a query ordering scheme including the sorting-based training data generation algorithm (SODDY) and the trie-based training data generation algorithm (TEDDY) with respect to string data of “joseph biden” and three query strings of “jo”, “joe”, and “john”.

The table on the left shows that, via the SODDY algorithm, the query strings are sorted and a longest common prefix between adjacent query strings is stored.

Via the SODDY algorithm, after table D is calculated for query string “jo”, only row i=3 needs to be calculated for query string “joe”, and only rows i=3 and i=4 need to be calculated for query string “john”.

The graph on the right shows a trie structure generated from the query strings via the TEDDY algorithm. When searching a corresponding trie via the TEDDY algorithm, table D for query string “jo” is calculated in node 2. In subsequently visiting node 3, only row i=3 is calculated in table D calculation for query string “joe”, and for query string “john”, only rows i=3 and i=4 are calculated when visiting node 4 and node 5, respectively.

### <Training Data Generation Algorithm>

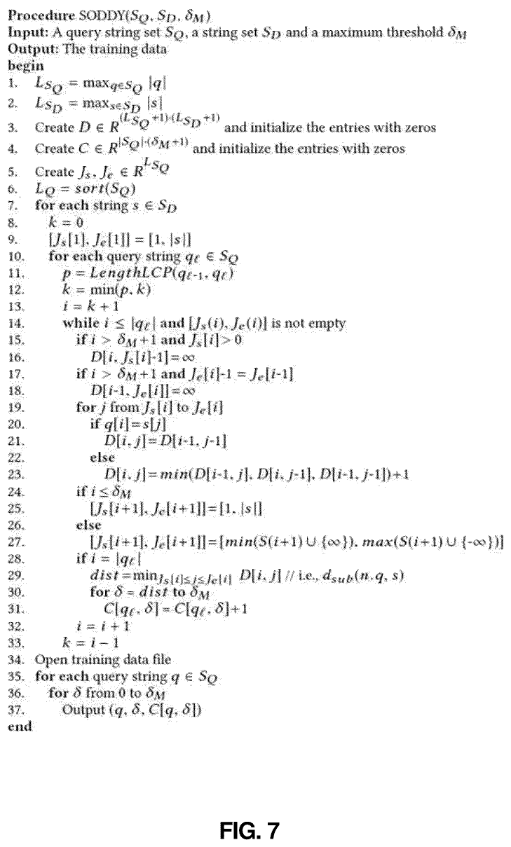

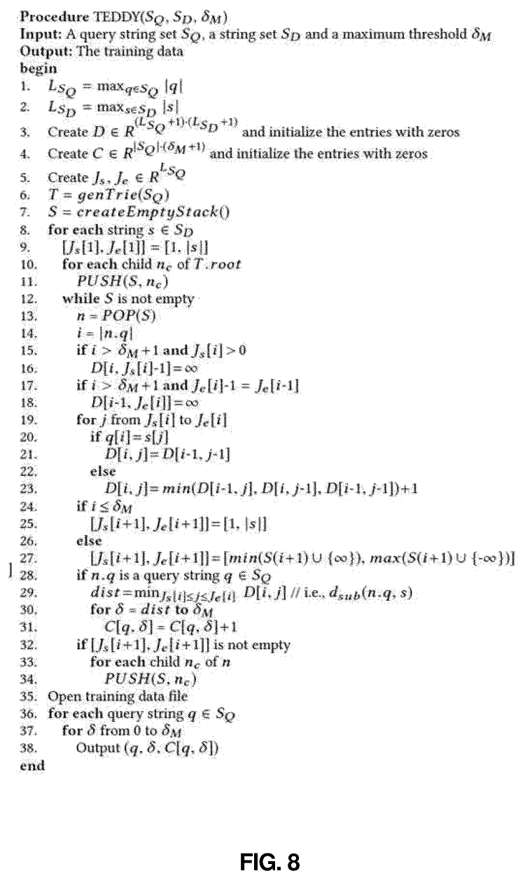

Pseudo-codes for the data generation algorithms proposed in the present disclosure are disclosed in FIG. 7 and FIG. 8.

Commonly via the data generation algorithms, query string set S_{Q}, data string set S_{D}, and maximum distance threshold δ_{M} are received, cardinalities c (q,δ) are calculated for all queries (q,δ) satisfying q∈S_{Q}, 0≤δ≤δ_{M}, and training data is returned.

FIG. 7 shows pseudo-codes for the sorting-based training data generation algorithm (SODDY). In lines 1-5, table D for dynamic programming, table C for cardinality storage, and Jₛ,Jₑ for storing a required column interval are generated.

Query string S_{Q} is sorted alphabetically in line 6, a substring edit distance to l-th query string qₗ is calculated for every data string s in line 29, and then a cardinality for a query having qₗ is calculated in lines 30-31.

FIG. 8 shows pseudo-codes for the trie-based training data generation algorithm (TEDDY). Main differences from the SODDY algorithm are as follows. In line 6, a trie is generated from query strings. The trie is searched for every data string s, and whenever query string q is found, a substring edit distance from q is calculated in line 29, and then a cardinality for a query having qₗ is calculated in lines 30-31.

### <Prefix-Augmented Training Data>

For substring similarity query (q,δ), data obtained by calculating cardinalities for all prefix queries in addition to cardinality c(q,δ) of the query is called prefix-augmented training data.

The prefix-augmented training data for the substring similarity query (joe, δ) is as follows.

$$( joe , δ , \tilde{c} ( j , δ ) , \tilde{c} ( jo , δ ) , \tilde{c} ( joe , δ ) )$$

Since the training data generation algorithms proposed in the present disclosure utilize common computation, prefix-augmentation data can be efficiently generated.

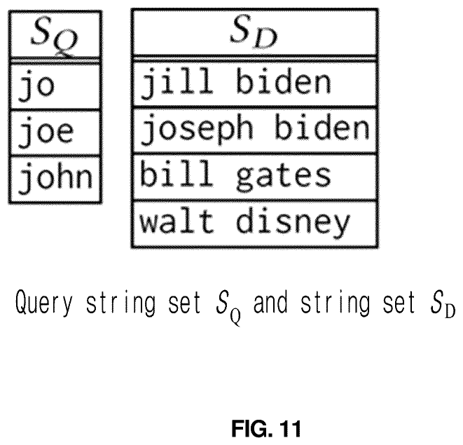

To review, examples of query string set S_{Q} and string set S_{D} are illustrated in FIG. 11. In this case, prefix-augmented training data is generated as shown in FIG. 11. When query (“joe”, 1) is given, prefixes of a query string “joe” are “j”, “jo”, and “joe”. Cardinalities of queries made with the respective prefixes are 2, 1, and 0 in order.

### <Training Data Generation>

When a substring edit distance is calculated via dynamic programming, calculation is performed only within a required column interval.

FIG. 10 shows a procedure of calculating a substring edit distance of query string “joe biden” and data string “joseph (joe) biden”. In a traditional method, the entire two-dimensional array needs be filled, but in the proposed algorithm, only colored areas are calculated. A distance greater than δ_{M} in the two-dimensional array does not need an exact value and is thus expressed as ∞.

In addition, computation redundant for a prefix appearing commonly in query strings is reduced. In order to effectively achieve this, a trie is generated using query strings, and only for nodes that appear in the trie, rows of the table used for dynamic programming are calculated.

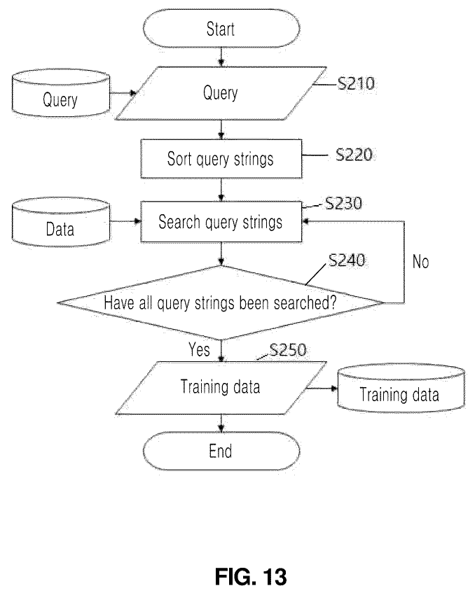

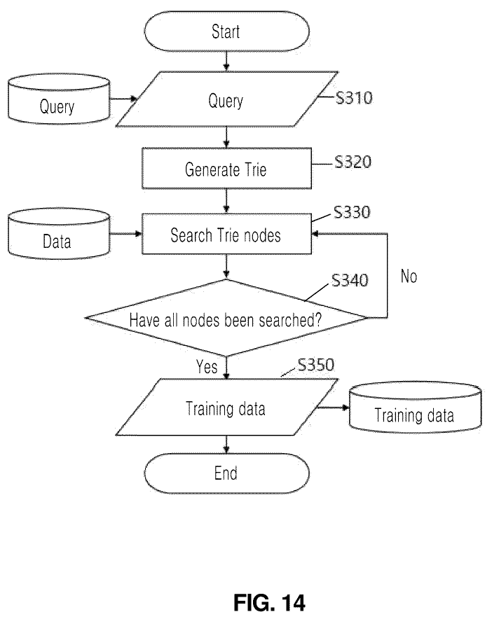

FIG. 13 is a flowchart illustrating a procedure of generating training data by using the sorting-based training data generation algorithm (SODDY), and FIG. 14 is a flowchart illustrating a procedure of generating training data by using the trie-based training data generation algorithm (TEDDY).

The processor 110 may use the SODDY or TEDDY algorithm to generate training data.

Referring to FIG. 13, the processor 110 may receive query string set S_{Q} in operation S210, sort strings existing in queries of query string set S_{Q} alphabetically in operation S220, receive data string set S_{D} and maximum threshold δ_{M} and search for all queries q∈S_{Q}, 0≤δ≤δ_{M} satisfying a condition requiring to be smaller than maximum threshold δ_{M} in operations S230 to S240, calculate cardinalities c(q,δ) for the searched queries (q,δ), and generate training data including a pair of a query and a cardinality to store the same in a training data DB in operation S250.

Referring to FIG. 14, the processor 110 may receive query string set S_{Q} in operation S310 to generate a trie from query strings in operation S320, may search the trie for each data string s of data string set S_{D}, calculate a substring edit distance from q whenever query string q is found, and then calculate a cardinality for a found query in operations S330 to S340, and may generate training data including a pair of a query and a cardinality and store the training data in a training data DB in operation S350.

Hereinafter, description will be provided for a method of training a deep learning model to predict a cardinality for an approximate substring query by using the training data generated in operation S140, thereby generating a cardinality prediction model.

### Deep Learning Model Training

### <Dream) Model (Deep Cardinality Estimation of Approximate Substring Queries)>

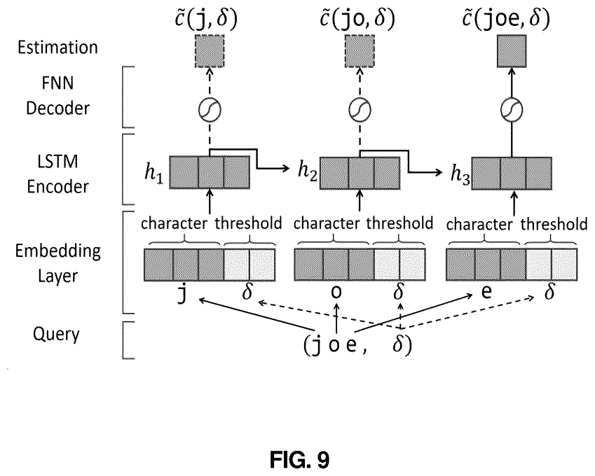

FIG. 9 is a structural diagram illustrating a structure of a cardinality prediction deep learning model according to an embodiment of the present disclosure.

In the present disclosure, the deep learning model Dream for cardinality prediction uses a sequential model, such as RNN.

In FIG. 9, a given query string is “joe”, and characters are received one by one along with maximum distance threshold δ. Each received threshold and character are vectorized via an embedding layer.

A corresponding cardinality is predicted by inputting both a vector for a character and a vector for a threshold to a sequential model.

Final cardinality c(q,δ) is output in the last operation.

### <Traditional Learning Method>

When a typical traditional learning method is used, in order to train a deep learning model, a model parameter is updated so that actual cardinality c(q,δ) and cardinality c (q,δ) predicted by the model are similar.

The following loss function used in most prediction models using deep learning is also used in the present disclosure.

$${L}_{q , δ} = {( log ( c ( q , δ ) ) - log ( \tilde{c} ( q , δ ) ) )}^{2}$$

Gradient descent is used to update a parameter of the model in a way the loss function decreases. When a model parameter is θ, a learning coefficient is η, and the loss function is L, a general gradient descent method is as follows.

$${θ}^{t + 1} = {θ}^{t} - η \cdot {∇}_{θ} L$$

### <Packed Learning Method>

In the present disclosure, a deep learning model training method using training data including prefix-augmented data is as follows. Index set I is generated by randomly selecting b indexes from among indexes indicating training data.

A batch, which is a unit via which training data corresponding to index set I enables training of model parameters, is configured.

For selected query (qᵢ,δ), cardinalities \tilde{c}(qᵢ[1,j],δᵢ) corresponding to all prefixes qᵢ[1,j] of qᵢ are calculated during a procedure of calculating \tilde{c}(qᵢ[1,j],δᵢ) by a Dream model.

$${L}_{packed} = \frac{1}{\vert I \vert} {\sum }_{i ∈ I} {\sum }_{j = 1}^{\vert {q}_{i} \vert} {L}_{{q}_{i} [ 1 , j ] , {δ}_{i}}$$

$$I ⊂ \{ i \vert 1 \leq i \leq \vert {S}_{Q} \vert \cdot ( {δ}_{M} + 1 ) \}$$

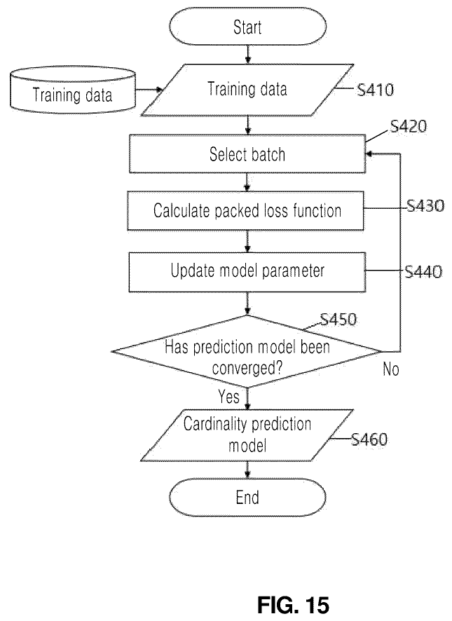

In other words, as illustrated in the flowchart of FIG. 15, the processor 110 may receive training data including prefix-augmented training data in operation S410, and may generate index set I by selecting b random indexes from among indexes assigned to the training data, and select a batch of size b in operation S420. Here, the batch refers to a unit via which the training data corresponding to index set I enables training of parameters of the deep learning model.

Subsequently, after calculating loss function L_{packed} for cardinalities corresponding to multiple prefix queries and a query within the batch in operation S430, model parameters are updated using a gradient descent method in operation S440.

Subsequently, after cardinality prediction model convergence, a cardinality prediction model may be generated by returning the trained model, in operations S450 to S460.

The present disclosure is different from conventional technology in view of including a data generation procedure for deep learning model training for cardinality prediction. Generating of a final prediction model, which includes the training data generation procedure, may be more accurate and require less time compared to conventional technology. Via this technology, a trained model may be obtained quickly even in a data changing environment.

In addition, the present disclosure can be used in a cardinality prediction module within a database system. Since the cardinality prediction module according to the embodiments of the present disclosure is used in a part of generating a query execution scheme, performance improvement of the module is expected to improve query execution processing performance and approximate estimation performance of a corresponding query.

The method according to an embodiment of the present disclosure described above can be implemented as computer-readable codes on a medium in which a program is recorded. Computer-readable media includes all types of recording devices that store computer system-readable data. Examples of computer-readable media include a hard disk drive (HDD), a solid-state disk (SSD), a silicon disk drive (SDD), a ROM, a RAM, a CD-ROM, a magnetic tape, a floppy disk, an optical data storage device, etc.

The aforementioned descriptions for the embodiments of the present disclosure are for illustration purposes, and those skilled in the art, to which the present disclosure belongs, will be able to understand that modification to other specific forms can be easily achieved without changing the technical spirit or essential features of the present disclosure. Therefore, it should be understood that the embodiments described above are illustrative and are not restrictive in all respects. For example, each element described as one type may be implemented in a distributed manner, and similarly, elements described as being distributed may also be implemented in a combined form.

The scope of the present disclosure is indicated by claims to be described hereinafter rather than the detailed description, and all changes or modifications derived from the meaning and scope of the claims and their equivalent concepts should be interpreted as being included in the scope of the present disclosure.

What is claimed is:

1. A method for generating a cardinality prediction model for an approximate substring query, the method comprising:
receiving a query string set for a data string set stored in a database;
configuring a maximum distance threshold for a substring edit distance defined as the closest distance among edit distances between a query string and all possible substrings of a data string;
generating training data comprising a pair of a query, which satisfies a condition that a substring edit distance needs to be smaller than the maximum distance threshold, and a cardinality for the query; and
training, using the training data, a deep learning model to predict a cardinality for an approximate substring query.

2. The method of claim 1, wherein the generating of the training data comprises:
calculating a substring edit distance for the query string and the data string;
comparing the substring edit distance with the maximum distance threshold; and
according to a result of the comparison, acquiring a cardinality, based on a data string which satisfies the condition that the substring edit distance needs to be smaller than the maximum distance threshold.

3. The method of claim 2, further comprising, before the calculating of the substring edit distance, searching for a common prefix of two different query strings in the query string set,
wherein, in case that the substring edit distance for the query string and the data string is calculated, substring edit distance calculation for the common prefix is shared without repetition.

4. The method of claim 3, wherein, for the generating of the training data, a sorting-based training data generation algorithm (SODDY) or a trie-based training data generation algorithm (TEDDY) is used.

5. The method of claim 4, comprising, in case that the sorting-based training data generation algorithm (SODDY) is used:
alphabetically sorting query strings in the query string set;
calculating and storing a longest common prefix length for two different adjacent query strings; and
while searching the query strings in a sorted order, calculating the substring edit distance,
wherein, substring edit distance calculation for the common prefix is shared without repetition.

6. The method of claim 4, comprising, in case that the trie-based training data generation algorithm (TEDDY) is used:
generating a trie based on the query strings; and
performing a depth-first search starting from a root node of the trie, and calculating the substring edit distance for the data string starting from a longest common prefix of the query strings.

7. The method of claim 1, wherein the generating of the training data further comprises:
generating multiple prefix queries by classifying prefixes for the query; and
generating prefix-augmented training data by calculating cardinalities for the respective multiple prefix queries.

8. The method of claim 7, wherein the training of the deep learning model comprises:
receiving the training data comprising the prefix-augmented training data;
generating index set I by selecting b random indexes among indexes assigned to the training data;
configuring a batch based on a unit via which training data corresponding to index set I enables training of a parameter of the deep learning model; and
updating the parameter of the deep learning model, based on a loss function for cardinalities corresponding to the multiple prefix queries and the query within the batch.

9. A device for generating a cardinality prediction model for an approximate substring query, the device comprising:
a processor; and
a memory connected to the processor and configured to store at least one code executed by the processor,
wherein the processor is configured to perform:
receiving a query string set for a data string set stored in a database;
configuring a maximum distance threshold for a substring edit distance defined as the closest distance among edit distances between a query string and all possible substrings of a data string;
generating training data comprising a pair of a query, which satisfies a condition that a substring edit distance needs to be smaller than the maximum distance threshold, and a cardinality for the query; and
training, using the training data, a deep learning model to predict a cardinality for an approximate substring query.

10. The device of claim 9, wherein the processor is configured to perform, for the generating of the training data:
calculating a substring edit distance for the query string and the data string;
comparing the substring edit distance with the maximum distance threshold; and
according to a result of the comparison, acquiring a cardinality, based on a data string which satisfies the condition that the substring edit distance needs to be smaller than the maximum distance threshold.

11. The device of claim 10, wherein the processor is configured to perform, before the calculating of the substring edit distance, searching for a common prefix of two different query strings in the query string set,
wherein, in case that the substring edit distance for the query string and the data string is calculated, substring edit distance calculation for the common prefix is shared without repetition.

12. The device of claim 11, wherein the processor is configured to use, for the generating of the training data, a sorting-based training data generation algorithm (SODDY) or a trie-based training data generation algorithm (TEDDY).

13. The device of claim 12, wherein the processor is configured to perform, in case that the sorting-based training data generation algorithm (SODDY) is used:
alphabetically sorting query strings in the query string set;
calculating and storing a longest common prefix length for two different adjacent query strings; and
while searching the query strings in a sorted order, calculating the substring edit distance,
wherein, substring edit distance calculation for the common prefix is shared without repetition.

14. The device of claim 12, wherein the processor is configured to perform, in case that the trie-based training data generation algorithm (TEDDY):
generating a trie based on the query strings; and
performing a depth-first search starting from a root node of the trie, and calculating the substring edit distance for the data string starting from a longest common prefix of the query strings.

15. The device of claim 9, wherein the processor is further configured to perform, for the generating of the training data:
generating multiple prefix queries by classifying prefixes for the query; and
generating prefix-augmented training data by calculating cardinalities for the respective multiple prefix queries.

16. The device of claim 15, wherein the processor is configured to perform, for the training of the deep learning model:
receiving the training data comprising the prefix-augmented training data;
generating index set I by selecting b random indexes among indexes assigned to the training data;
configuring a batch based on a unit via which training data corresponding to index set I enables training of a parameter of the deep learning model; and
updating the parameter of the deep learning model, based on a loss function for cardinalities corresponding to the multiple prefix queries and the query within the batch.
